(19) United States
(12) Patent Application Publication
(10) Pub. No.: US 2026/0298084 A1
(43) Pub. Date: Oct. 1, 2026

(54) METHOD AND SYSTEM FOR PREDICTING BLASTING VIBRATION INSIDE SURROUNDING ROCKS IN DEEP BURIED TUNNELS

(71) Applicant: NORTHEASTERN UNIVERSITY, Shenyang (CN)

(72) Inventors: Benguo HE, Shenyang (CN); Huawei XU, Shenyang (CN); Xiating FENG, Shenyang (CN); Hongyuan FU, Shenyang (CN); Chong REN, Shenyang (CN)

(21) Appl. No.: 19/447,750

(22) Filed: Jan. 13, 2026

(30) Foreign Application Priority Data
Mar. 26, 2025 (CN) 202510364680.3

(51) Int. Cl. E21D 9/00; E21F 17/18

(52) U.S. Cl. CPC E21D 9/006; E21F 17/18

(57) ABSTRACT

A method and system for predicting blasting vibration inside surrounding rocks in deep buried tunnels. The method includes: horizontally drilling a plurality of test boreholes from a pilot tunnel into the surrounding rocks, and mounting blasting vibration sensors; performing blasting on a subsequent tunnel, and acquiring vibration data; performing fitting with the vibration data and a blasting point distance of the test boreholes in a region in front of a tunnel face, thereby obtaining a first blasting vibration velocity prediction model in the region in front of the tunnel face; calculating an actual blasting point distance of the test boreholes in a region behind the tunnel face; and performing fitting with the actual blasting point distance and the vibration data of the test boreholes in the region behind the tunnel face to obtain a second blasting vibration velocity prediction model in the region behind the tunnel face.

### BACKGROUND OF THE INVENTION

### 1. Field of the Invention

The present invention relates to the technical field of tunnel blasting, and in particular to a method and system for predicting blasting vibration inside surrounding rocks in deep buried tunnels.

### 2. The Prior Arts

Deep projects are typically situated in extremely complex engineering geological environments characterized by high in-situ stress, intense tectonic activities, etc. These environmental factors make the projects highly prone to triggering hazards such as rock mass fracturing, rib spalling, large deformations, and rockbursts during construction. Particularly in tunnels constructed using a drilling-blasting method, blasting disturbances can accelerate occurrence of these hazards. Thus, investigating mechanisms by which blasting impacts induce various hazards has become a current research focus. However, the prior art exhibits limitations in monitoring blasting stress waves. When the blasting stress waves encounter air media, diffraction phenomena occur. The currently used surrounding rock surface testing methods cannot effectively solve the problem, thereby failing to accurately characterize the propagation behavior characteristic of the blasting stress waves in complex geological environments.

### SUMMARY OF THE INVENTION

The present invention aims to provide a method, device and apparatus for predicting blasting vibration inside surrounding rocks in deep buried tunnels, and a computer-readable storage medium to solve the above problems. In order to achieve the purpose, the present invention adopts the following technical solution.

In a first aspect, further provided in the present application is a method for predicting blasting vibration inside surrounding rocks in deep buried tunnels, including:

Horizontally drilling a plurality of test boreholes from a pilot tunnel into the surrounding rocks, and mounting blasting vibration sensors in sequence at a borehole bottom of each test borehole, wherein the plurality of test boreholes using a tunnel face of a subsequent tunnel as a symmetry plane are uniformly distributed in a region in front of and behind the tunnel face.

Performing blasting on the subsequent tunnel, and acquiring vibration data of the test boreholes that are collected by the blasting vibration sensors.

Acquiring a blasting point distance for the test boreholes in the region in front of the tunnel face, and fitting a Sadovsky formula by using the vibration data and the blasting point distance of the test boreholes in the region in front of the tunnel face, thereby obtaining a first blasting vibration velocity prediction model in the region in front of the tunnel face.

Acquiring a blasting charge amount of the subsequent tunnel, substituting the vibration data of the test boreholes in the region behind the tunnel face and the blasting charge amount into the first blasting vibration velocity prediction model, and performing calculation to obtain an actual blasting point distance that stress waves are propagated from a blasting source to the test boreholes.

Fitting a Sadovsky formula by using the actual blasting point distance and the vibration data of the test boreholes in the region behind the tunnel face to obtain a second blasting vibration velocity prediction model in the region behind the tunnel face.

In a second aspect, further provided in the present application is a system for predicting blasting vibration inside surrounding rocks in deep buried tunnels, including:

An arrangement module configured to horizontally drill a plurality of test boreholes from a pilot tunnel into the surrounding rocks, and mount blasting vibration sensors in sequence at a borehole bottom of each test borehole, wherein the plurality of test boreholes using a tunnel face of a subsequent tunnel as a symmetry plane are uniformly distributed in a region in front of and behind the tunnel face.

An acquisition module configured to perform blasting on the subsequent tunnel, and acquire vibration data of the test boreholes that are collected by the blasting vibration sensors.

A first fitting module configured to acquire a blasting point distance for the test boreholes in the region in front of the tunnel face, and fit a Sadovsky formula by using the vibration data and the blasting point distance of the test boreholes in the region in front of the tunnel face, thereby obtaining a first blasting vibration velocity prediction model in the region in front of the tunnel face.

A first calculation module configured to according to the first blasting vibration velocity prediction model and the vibration data of the test boreholes in the region behind the tunnel face, performing calculation to obtain an actual blasting point distance of the test boreholes in the region behind the tunnel face.

A second fitting module configured to fit the Sadovsky formula by using the actual blasting point distance and the vibration data of the test boreholes in the region behind the tunnel face to obtain a second blasting vibration velocity prediction model in the region behind the tunnel face.

In a third aspect, further provided in the present application is an apparatus for predicting blasting vibration inside surrounding rocks in deep buried tunnels, including:

A memory which is configured to store computer programs.

A processor which is configured to implement steps of the method for predicting blasting vibration inside surrounding rocks in deep buried tunnels during execution of the computer programs.

In a fourth aspect, further provided in the present application is a computer-readable storage medium, wherein the computer programs are stored on the computer-readable storage medium, and when the computer programs are executed by the processor, the steps of the above method for predicting blasting vibration inside surrounding rocks in deep buried tunnels are implemented.

The present invention has the beneficial effects:
1. In the present invention, by horizontally drilling the plurality of test boreholes from the pilot tunnel into the surrounding rocks, and mounting the improved blasting vibration sensors at the borehole bottoms, the ingenious design of the blasting vibration sensors ensures its stability during blasting and the accuracy of data acquisition, the mounting and fixing process is simple and rapid, construction costs and personnel workload are reduced, comprehensive and high-precision monitoring of blasting vibration is achieved, and the propagation characteristics of the blasting stress waves in different directions can be effectively captured, thereby providing accurate data support for vibration prediction.
2. According to the present invention, fitting is performed by using the vibration data and the blasting point distance from the test boreholes in the region in front of the tunnel face to obtain the first blasting vibration velocity prediction model, according to the first blasting vibration velocity prediction model and the date of the test boreholes in the region behind the tunnel face, calculation is performed to obtain the actual blasting point distance in the region behind the tunnel face, and further fitting is performed to obtain the second blasting vibration velocity prediction model, thereby more accurately predicting the propagation condition of blasting vibration in the surrounding rocks in the region behind the tunnel face, and providing an important reference for safety protection during construction of the region behind the tunnel face and optimized design of blasting.

Additional features and advantages of the present invention will be set forth in the subsequent specification, and in part will be apparent from the specification, or may be learned by practice of the present invention. The objectives and other advantages of the present invention may be realized and attained by the structures particularly pointed out in the written description, claims, and drawings.

### BRIEF DESCRIPTION OF DRAWINGS

In order to provide a clearer understanding of the technical solutions in the embodiments of the present invention, the following offers a brief introduction to the accompanying drawings required for describing the embodiments. It should be understood that the following drawings merely depict certain embodiments of the present invention and therefore shall not be considered as limiting the scope. For a person of ordinary skilled in the art, other related drawings may also be derived from these drawings without the exercise of inventive effort.

FIG. 1 is a schematic flowchart illustrating a method for predicting blasting vibration inside surrounding rocks in deep buried tunnels in an embodiment of the present invention;

FIG. 2 is a top view of a tunnel in an embodiment of the present invention;

FIG. 3 is a sectional view of a tunnel in an embodiment of the present invention;

FIG. 4 is a sectional view of blasting vibration sensors in an embodiment of the present invention;

FIG. 5 is a schematic diagram of a support rod in an embodiment of the present invention;

FIG. 6 is a schematic diagram of push-pull rods in an embodiment of the present invention;

FIG. 7 is a schematic diagram showing an overall structure of blasting vibration sensors in an embodiment of the present invention;

FIG. 8 is a schematic structural diagram of traction ropes in an embodiment of the present invention;

FIG. 9 is a schematic structural diagram of a system for predicting blasting vibration inside surrounding rocks in deep buried tunnels in an embodiment of the present invention; and

FIG. 10 is a schematic structural diagram of an apparatus for predicting blasting vibration inside surrounding rocks in deep buried tunnels in an embodiment of the present invention.

In the drawings, reference numerals are as follows:
1, sensor body; 2, accommodating chamber; 21, through hole; 3, blocking layer; 4, push-pull device; 41, support rod; 411, first rod; 412, second rod; 413, third rod; 414, fourth rod; 415, fifth rod; 416, sixth rod; 417, fixing block; 42, push-pull rod; 43, spring; 44, slider; 45, button; 46, end handle; 461, leaf spring; 47, clamping port; 48, rod cap; 49, pulley assembly; 491, fixed pulley; 492, movable pulley; 493, traction rope; 494, hook; 495, plastic rigid pipe; 800, apparatus for predicting blasting vibration inside surrounding rocks in deep buried tunnels; 801, processor; 802, memory; 803, multimedia component; 804, I/O Interface; 805, communication component.

### DETAILED DESCRIPTION OF THE PREFERRED EMBODIMENT

In order to more clearly illustrate the objectives, technical solutions, and advantages of the embodiments of the present invention, the technical solutions in the embodiments of the present invention will be described clearly and completely below in conjunction with the accompanying drawings. It is apparent that the described embodiments are merely a part, not all, of the embodiments of the present invention. The components of the embodiments of the present invention, as generally described and illustrated in the accompanying drawings herein, can be arranged and designed in a wide variety of different configurations. Thus, the following detailed description of the embodiments of the present invention, provided in the accompanying drawings, is not intended to limit the scope of the claimed invention, but is merely representative of selected embodiments of the present invention. All other embodiments obtained by a person of ordinary skill in the art based on the embodiments of the present invention without creative efforts shall fall within the scope of the present invention.

It should be noted that: similar reference numerals and letters denote like items in the following drawings, and thus, once an item is defined in one drawing, it may not be further defined and explained in subsequent drawings. Meanwhile, in the description of the present invention, terms such as “first,” “second,” etc., are used solely for distinguishing description and should not be construed as indicating or implying relative importance.

### Embodiment 1

Provided in the embodiment is a method for predicting blasting vibration inside surrounding rocks in deep buried tunnels.

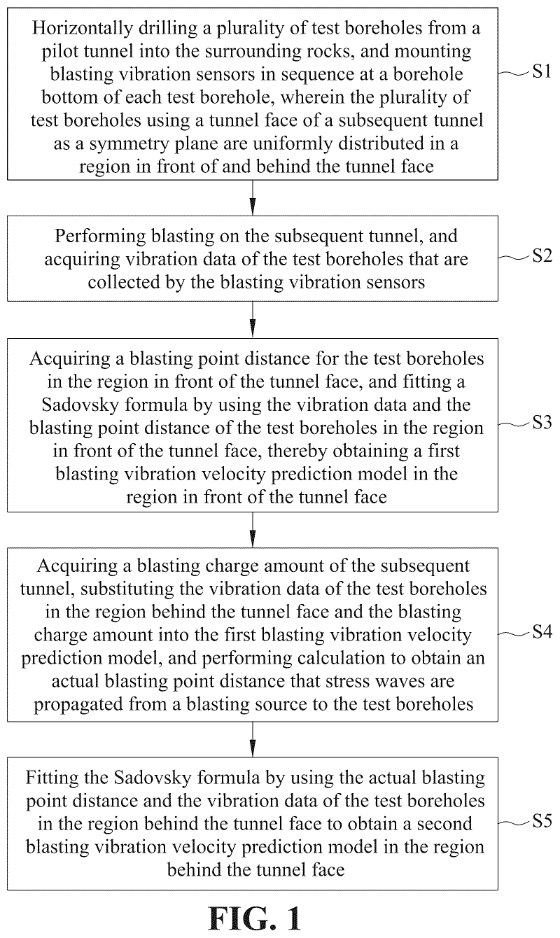

Referring to FIG. 1 to FIG. 3, the method includes:
S1: Horizontally drilling a plurality of test boreholes from a pilot tunnel into surrounding rocks, and mounting blasting vibration sensors in sequence at a borehole bottom of each test borehole, wherein the plurality of test boreholes using a tunnel face of a subsequent tunnel as a symmetry plane are uniformly distributed in a region in front of and behind the tunnel face;

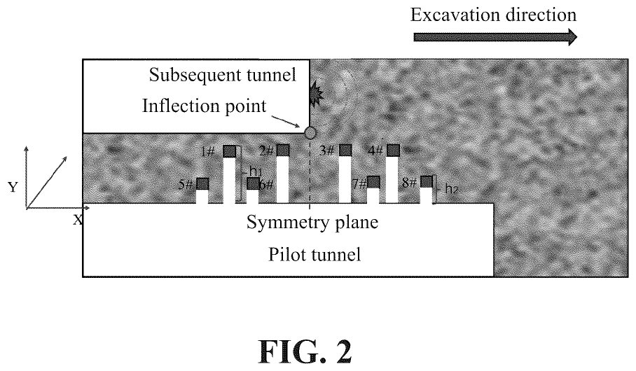

Specifically, step S1 includes:
S11: A horizontal height lᵤ for drilling the test boreholes is determined in a wall of the pilot tunnel, and a horizontal distance between two adjacent test boreholes is determined.
S12: Drilling depths of the test boreholes are acquired, wherein the drilling depths include a first depth and a second depth, and the plurality of test boreholes are drilled alternately according to the first depth and the second depth.
S13: At least 4 test boreholes are drilled in sequence in the region in front of the tunnel face according to the horizontal height, the horizontal distance, and the drilling depths; as shown in FIG. 2, the test boreholes in the region in front of the tunnel face are numbered 3 #, 4 #, 7 # and 8 #, respectively, wherein the drilling depths of the test boreholes numbered 3 # and 4 # are the first depth h₁, and the drilling depths of the test boreholes numbered 7 # and 8 # are the second depth h₂.
S14: The tunnel face is used as a symmetry plane, and an identical number of test boreholes are symmetrically drilled in the region behind the tunnel face, as shown in FIG., the test boreholes in the region in front of the tunnel face are numbered 1 #, 2 #, 5 # and 6 #, respectively, wherein the drilling depths of the test boreholes numbered 1 # and 2 # are the first depth h₁, and the drilling depths of the test boreholes numbered 5 # and 6 # are the second depth h₂.

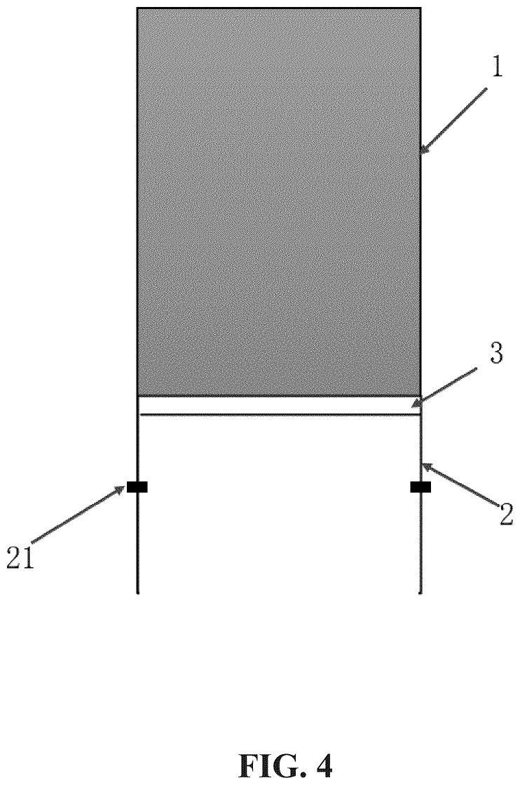

As shown in FIG. 4, in the embodiment, each blasting vibration sensor includes:

A sensor body 1, the sensor body 1 being located at an upper part of the blasting vibration sensor.

In the embodiment, the sensor body 1 is an instrument integrating a high-range blasting vibration sensor and an ISV-613A integrated intelligent vibration measuring instrument, wherein an acquisition system for a low-range sensor is arranged in the ISV-613A integrated intelligent vibration measuring instrument, such that vibration velocity measurement under low disturbance response can be realized; the low-range sensor arranged in the ISV-613A integrated intelligent vibration measuring instrument includes main parameters: triaxial (X, Y, Z) vibration sensors with a vibration velocity measurement range of 0.008-33 cm/s, frequency response of 1-1 kHz, and operating temperature of minus 20-60° C.

The integrated sensor body 1 has main parameters: blasting vibration velocity measurement range of 0.01-2500 mm/s, sensitivity of 2 mv/mm/s, frequency response range of 4-3 kHz, operating temperature of minus 20-80° C., and triaxial (X, Y, Z) vibration sensors.

The sensor body 1 is configured with program-controlled switching software, selects operation modes according to field requirements to operate, can give consideration to vibration monitoring requirements caused by low disturbance and vibration monitoring requirements caused by strong disturbances.

The operation modes mainly include the following two modes:
1) A strong disturbance mode: a large-range sensor is activated for operation.
2) A low disturbance mode: the low-range sensor arranged in the ISV-613A integrated intelligent vibration measuring instrument is activated for operation.

Switching between the two operation modes can be achieved through the program-controlled switching software, which can give consideration to vibration velocity measurement requirements under different disturbance, and different modes are selected according to field requirements for testing different environments.

An accommodation chamber 2, the accommodation chamber 2 being located at a lower part of the blasting vibration sensor, wherein a blocking layer 3 is provided between each accommodation chamber 2 and the sensor body 1, and a plurality of through holes 21 are provided in each accommodation chamber 2 in a peripheral direction; and preferably, the blocking layer 3 consists of foam and a metal gasket, which avoids interference caused by each push-pull device 4 to the sensor body 1.

A push-pull device 4, the push-pull device being located inside the accommodation chamber 2, wherein a top of the push-pull device 4 is fixedly connected to a top surface inside the accommodation chamber 2, a plurality of support rods 41 of the push-pull device 4 extend outward along the plurality of through holes 21 to come in contact with an inner wall of the test borehole, thereby fixing the blasting vibration sensor in the test borehole.

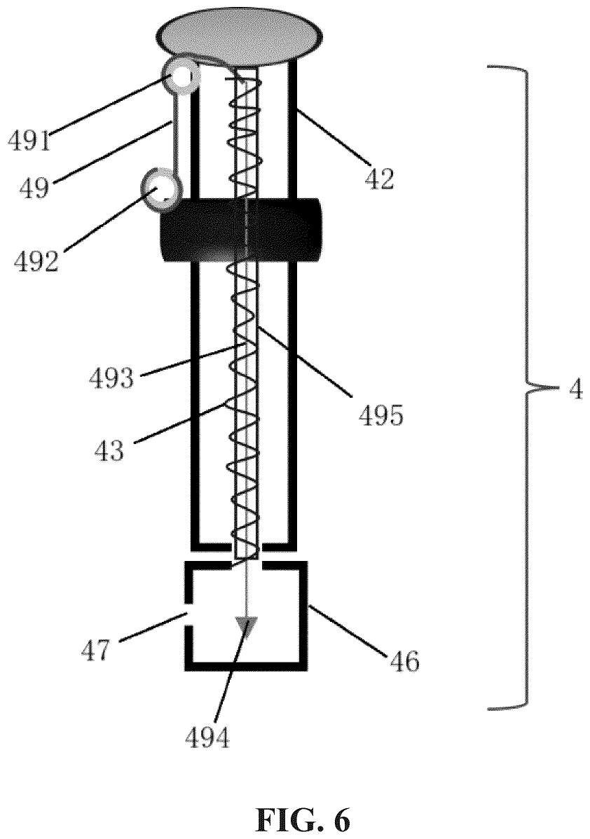

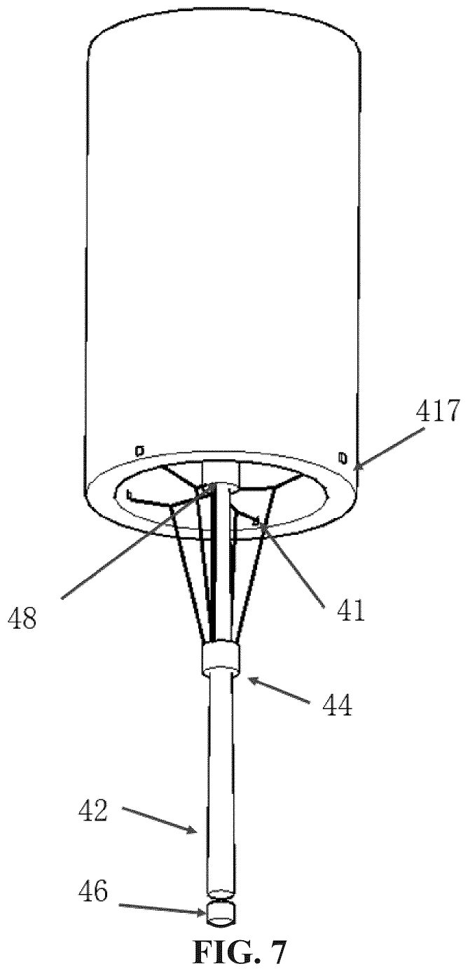

Preferably, as shown in FIG. 6 and FIG. 7, the push-pull device 4 includes:

A push-pull rod 42, wherein a spring 43 is provided inside each push-pull rod 42 in a vertical direction, a slider 44 is sleeved outside each push-pull rod 42 in a peripheral direction, the slider 44 axially slides along the push-pull rod 42, and when each slider 44 is close to an end handle 46, the spring 43 is in a compressed state; and a button 45 is provided below each push-pull rod.

The end handle 46, wherein a clamping port 47 is provided on a side wall of the end handle 46, the end handle 46 is fixedly connected to the button 45 through the clamping port 47, and a leaf spring 461 is further provided in each end handle 46.

A rod cap 48, the rod cap 48 being fixed to a top of the push-pull rod 42.

A pulley assembly 49, the pulley assembly including a fixed pulley 491, a movable pulley 492 and a traction rope 493, wherein each fixed pulley 491 is fixed to the rod cap 48, the movable pulley 492 is nested outside of the push-pull rod and moves axially along the push-pull rod 42, one end of the traction rope 493 is connected to the fixed pulley 491 and the movable pulley 492 in sequence, and the other end of the traction rope passes axially through an interior of the spring 43 and is connected to a hook 494.

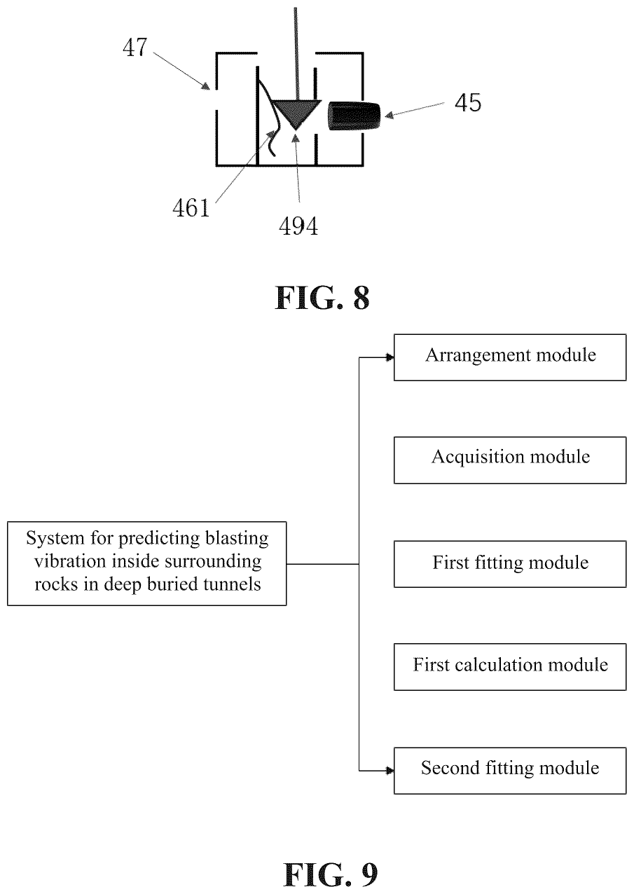

Preferably, as shown in FIG. 8, a plastic rigid pipe 495 is sleeved outside each traction rope 493, an upper part of the plastic rigid pipe 495 comes in contact with a bottom of the rod cap 48, and a lower part comes in contact with an upper part of the hook 494, thereby ensuring that each hook 494 connected to the traction rope 493 forms a buckle-style structure with the leaf spring 461. A length of the plastic rigid pipe 495 is designed according to the drilling depth of the test borehole.

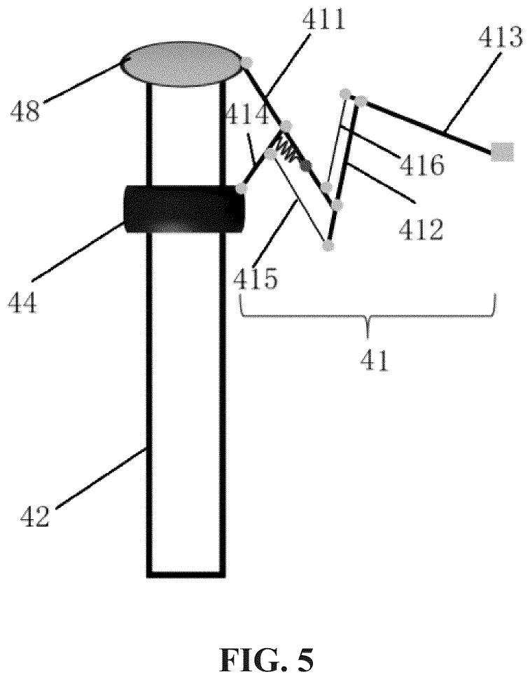

Preferably, as shown in FIG. 5, the support rod 41 includes a first rod 411, a second rod 412, a third rod 413, a fourth rod 414, a fifth rod 415 and a sixth rod 416.

One end of the first rod 411 is hinged with the rod cap 48, and the other end is hinged with a middle part of the second rod 412.

One end of the second rod 412 is hinged with one end of the third rod 413, and the other end is connected to one end of the fifth rod 415.

The other end of the third rod 413 extends out of the through hole 21 of the accommodation chamber 2 and is connected to a fixing block 417.

One end of the fourth rod 414 is connected to the slider 44, and the other end is hinged with a middle part of the first rod 411.

The other end of the fifth rod 415 is hinged with a middle part of the fourth rod 414.

One end of the sixth rod 416 is hinged with an end of the third rod 413, and the other end is hinged with the middle part of the first rod 411.

A spring is also connected between the end of the first rod 411 and the middle part of the fourth rod 414.

In the embodiment, when each slider 44 is pushed upward, the support rod 41 extends outward and pushes the fixing block 417 to fix the blasting vibration sensor in the test borehole, and when each support rod 41 retracts, the spring uses retraction force thereof to pull the first rod 411 for retraction.

Based on the above embodiment, the method further includes:
S2: Performing blasting on the subsequent tunnel, and acquiring vibration data of the test boreholes that are collected by the blasting vibration sensors.

Based on the above embodiment, the method further includes:
S3: Acquiring a blasting point distance for the test boreholes in the region in front of the tunnel face, and fitting a Sadovsky formula by using the vibration data and the blasting point distance of the test boreholes in the region in front of the tunnel face, thereby obtaining a first blasting vibration velocity prediction model in the region in front of the tunnel face.

Specifically, the Sadovsky formula is as follows:

$$v = {k ( \frac{{Q}^{1 / 3}}{R} )}^{a} . \qquad ( 1 )$$

In the formula: v represents the vibration velocity; k represents a coefficient related to factors such as a medium and blasting conditions; Q represents blasting charge amount; R represents the blasting point distance; and a represents a vibration attenuation coefficient.

After the blasting charge amount of the subsequent tunnel is acquired, the vibration velocities, the blasting point distances of the test boreholes numbered #3, #4, #7 and #8 and the blasting charge amount are used to fit the Sadovsky formula, respectively, to obtain k_{q} and a_{q}, and k_{q} and a_{q} are substituted into the Sadovsky formula to obtain a first blasting vibration velocity prediction model in the region in front of the tunnel face:

$${v}_{q} = {{k}_{q} ( \frac{{Q}^{1 / 3}}{R} )}^{{a}_{q}} . \qquad ( 2 )$$

In the formula, v_{q}, k_{q}, a_{q} represent the vibration velocity of the first blasting vibration velocity prediction model, the coefficient of the first blasting vibration velocity prediction model that is related to the medium and blasting conditions, and the vibration attenuation coefficient of the first blasting vibration velocity prediction model, respectively.

Based on the above embodiment, the method further includes:
S4: Acquiring the blasting charge amount of the subsequent tunnel, substituting the vibration data of the test boreholes in the region behind the tunnel face and the blasting charge amount into the first blasting vibration velocity prediction model, and performing calculation to obtain an actual blasting point distance that stress waves are propagated from a blasting source to the test boreholes.

In the embodiment, the vibration velocities the test boreholes numbered #1 and #2 and the blasting charge amount are respectively substituted into the first blasting vibration velocity prediction model to calculate the actual blasting point distance R₁ of the test borehole numbered #1 and the actual blasting point distance R₂ of the test borehole numbered #2.

Based on the above embodiment, the method further includes:
S5: Fitting the Sadovsky formula by using the actual blasting point distance and the vibration data of the test boreholes in the region behind the tunnel face to obtain a second blasting vibration velocity prediction model in the region behind the tunnel face.

Specifically, step S5 includes:
S51: Center coordinates (xₖₙ, yₖₙ, zₖₙ) of borehole openings of the test boreholes in the region behind the tunnel face are acquired.
S52: Inversion is performed according to the center coordinates of the borehole openings and drilling depths Ln to obtain center coordinates (x_{dn}, y_{dn}, z_{dn}) of the borehole bottoms of the test boreholes in the region behind the tunnel face, wherein

$$\sqrt{{( {x}_{k n} - {x}_{d n} )}^{2} + {( {y}_{k n} - {y}_{d n} )}^{2} + {( {z}_{k n} - {z}_{d n} )}^{2}} = {L}_{n} . \qquad ( 3 )$$

In the formula, n represents the n^{th} test hole, inversion is performed by using the above formula, so as to obtain center coordinates of the borehole bottom of each test borehole in the region behind the tunnel face, (xₖₙ, yₖₙ, zₖₙ) represent x-axis coordinates, y-axis coordinates and z-axis coordinates of a borehole opening, respectively, and (x_{dn}, y_{dn}, z_{dn}) represents x-axis coordinates, y-axis coordinates and z-axis coordinates of the borehole bottom, respectively.

S53: Coordinates (x₀, y₀, z₀) of the blasting source of the tunnel face are acquired, and according to the coordinates of the blasting source, the center coordinates of the borehole bottoms and the actual blasting point distance, inversion is performed by using a coordinate system inversion method to obtain a propagation path of the stress waves reaching the borehole bottoms of the test boreholes in the region behind the tunnel face.

Specifically, the propagation path of the stress waves reaching test borehole numbered 1 # is calculated by using the coordinate system inversion method, as follows:

$$\{ \begin{matrix}\sqrt{{( {x}_{p 1} - {x}_{0} )}^{2} + {( {y}_{p 1} - {y}_{0} )}^{2} + {( {z}_{p 1} - {z}_{0} )}^{2}} = {L}_{0} \\ \sqrt{{( {x}_{p 1} - {x}_{d 1} )}^{2} + {( {y}_{p 1} - {y}_{d 1} )}^{2} + {( {z}_{p 1} - {z}_{d 1} )}^{2}} = {L}_{01} \\ {L}_{0} + {L}_{01} = {R}_{1}\end{matrix} . \qquad ( 4 )$$

In the formula, (xₚ₁, yₚ₁, zₚ₁) represent x-axis coordinates, y-axis coordinates and z-axis coordinates of a point where the stress waves pass through the surrounding rocks on a side wall of a section of the tunnel face before reaching the test borehole numbered 1 #, namely coordinates of an inflection point, L₀ represents a distance between the blasting source and the inflection point, L₀₁ represents a distance between the inflection point and the test borehole numbered 1 #, and (x₀, y₀, z₀) represent x-axis coordinates, y-axis coordinates, and z-axis coordinates of the blasting source.

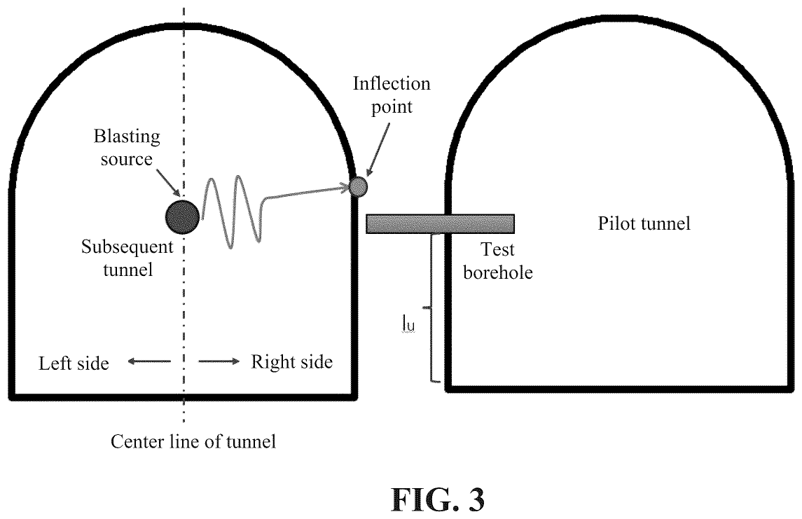

The coordinates of a right-section contour of the tunnel face of the subsequent tunnel are scanned using a total station, as shown in FIG. 3, scanned contour coordinate points are compiled, and a MATLAB programming-based screening algorithm is used to sequentially substitute each scanned contour coordinate point as (xₚ₁, yₚ₁, zₚ₁) into formula (1) for matching calculation, thereby obtaining the value of (xₚ₁, yₚ₁, zₚ₁).

Similarly, the propagation path of the stress waves reaching the test borehole numbered 1 # is calculated by using the coordinate system inversion method, thereby obtaining the coordinate point (xₚ₂, yₚ₂, zₚ₂) where the stress waves pass through the surrounding rocks on the side wall of the section of the tunnel face before reaching the test borehole numbered 2 #, (xₚ₂, yₚ₂, zₚ₂) represents x-axis coordinates, y-axis coordinates, and z-axis coordinates of the coordinate point where the stress waves pass through the surrounding rocks on the side wall of the section of the tunnel face before reaching the test borehole numbered 2 #, respectively.

S54: The Sadovsky formula is fitted on the basis of the propagation path to obtain the second blasting vibration velocity prediction model in the region behind the tunnel face.

Specifically, step S54 includes:
S541: Coordinates of the inflection point on the propagation path are acquired.

Since the inflection point where the stress waves pass through the surrounding blocks on the side wall of the section of the tunnel face is a fixed point, there are errors between (xₚ₁, yₚ₁, zₚ₁) and (xₚ₂, yₚ₂, zₚ₂), and thus, (xₚ₁, yₚ₁, zₚ₁) and (xₚ₂, yₚ₂, zₚ₂) are two different coordinate points. In the embodiment, a midpoint between (xₚ₁, yₚ₁, zₚ₁) and (xₚ₂, yₚ₂, zₚ₂) is taken as the inflection point where the stress waves pass through the surrounding blocks on the side wall of the section of the tunnel face, and thus, the coordinate (\dot{x}, \dot{y}, ż) of the inflection point on the propagation path is:

$$\{ \begin{matrix}\dot{x} = \frac{{x}_{p 1} + {x}_{p 2}}{2} \\ \dot{y} = \frac{{y}_{p 1} + {y}_{p 2}}{2} \\ \dot{z} = \frac{{z}_{p 1} + {z}_{p 2}}{2}\end{matrix} . \qquad ( 5 )$$

In the formula, (\dot{x}, \dot{y}, ż) represents x-axis coordinates, y-axis coordinates and z-axis coordinates of the inflection point on the propagation path.

S542: The actual blasting point distance R₅ of the test borehole numbered 5 # and the actual blasting point distance R₆ of the test borehole numbered 6 # are calculated according to the coordinates of the inflection point;

$${R}_{5} = \dot{{L}_{0}} + {L}_{05} . \qquad ( 6 )$$

In the formula, \dot{L}₀ represents a distance from the inflection point to a blasting point, and Los represents a distance from the inflection point to the test borehole numbered 5 #; a calculation method for R₆ is the same as that for R₅, and will not be reiterated here.

S543: The Sadovsky formula is fitted by using a propagation distance of the stress waves in the surrounding rocks, the vibration data of the test borehole in the region behind the tunnel face, and the blasting charge amount, to obtain the second blasting vibration velocity prediction model in the region behind the tunnel face.

In the embodiment, the Sadovsky formula is fitted by using propagation distances of the test boreholes numbered 5 # and 6 #, the vibration velocity, and the blasting charge amount, thereby obtaining the second blasting vibration velocity prediction model in the region behind the tunnel face:

$${v}_{g} = {{k}_{g} ( \frac{{Q}^{1 / 3}}{R} )}^{{a}_{g}} . \qquad ( 7 )$$

In the formula, v_{g}, k_{g}, a_{g} represent the vibration velocity of the second blasting vibration velocity prediction model, the coefficient of the second blasting vibration velocity prediction model that is related to the medium and blasting conditions, and the vibration attenuation coefficient of the second blasting vibration velocity prediction model, respectively.

It should be noted that the embodiment merely uses two test boreholes as the example to fit the second blasting vibration velocity prediction model. In actual operations, the more the test boreholes, the higher the accuracy of the fitted model.

### Embodiment 2

As shown in FIG. 9, provided in the embodiment is a system for predicting blasting vibration inside surrounding rocks in deep buried tunnels, the system including:

An arrangement module configured to horizontally drill a plurality of test boreholes from a pilot tunnel into the surrounding rocks, and mount blasting vibration sensors in sequence at the borehole bottom of each test borehole, wherein the plurality of test boreholes using a tunnel face of a subsequent tunnel as a symmetry plane are uniformly distributed in a region in front of and behind the tunnel face.

An acquisition module configured to perform blasting on a subsequent tunnel, and acquire vibration data of the test boreholes that are collected by blasting the vibration sensors.

A first fitting module configured to acquire a blasting point distance for the test boreholes in the region in front of the tunnel face, and fit a Sadovsky formula by using the vibration data and the blasting point distance of the test boreholes in the region in front of the tunnel face, thereby obtaining a first blasting vibration velocity prediction model in the region in front of the tunnel face.

A first calculation module configured to acquire a blasting charge amount of the subsequent tunnel, substitute the vibration data of the test boreholes in a region behind the tunnel face and the blasting charge amount into the first blasting vibration velocity prediction model, and perform calculation to obtain an actual blasting point distance that stress waves are propagated from a blasting source to the test boreholes.

A second fitting module configured to fit the Sadovsky formula by using the actual blasting point distance and the vibration data of the test boreholes in the region behind the tunnel face to obtain a second blasting vibration velocity prediction model in the region behind the tunnel face.

Based on the above embodiments, the arrangement module includes:

A first determination unit configured to determine a horizontal height for drilling the test boreholes in a wall of the pilot tunnel, and determine a horizontal distance between two adjacent test boreholes.

A first acquisition unit configured to acquire drilling depths of the test boreholes, wherein the drilling depths include a first depth and a second depth, and the plurality of test boreholes are drilled alternately according to the first depth and the second depth.

A first arrangement unit configured to drill at least 4 test boreholes in sequence in the region in front of the tunnel face according to the horizontal height, the horizontal distance, and the drilling depths.

A second arrangement unit configured to, by using the tunnel face as the symmetry plane, symmetrically drill an identical number of test boreholes in the region behind the tunnel face.

Based on the above embodiments, the second fitting module includes:

A third acquisition unit configured to acquire center coordinates of borehole openings of the test boreholes in the region behind the tunnel face.

A first inversion unit configured to perform inversion according to the center coordinates of the borehole openings and drilling depths to obtain center coordinates of borehole bottoms of the test boreholes in the region behind the tunnel face.

A second inversion unit configured to acquire coordinates of the blasting source of the tunnel face, and according to the coordinates of the blasting source, the center coordinates of the borehole bottoms and the actual blasting point distance, perform inversion by using a coordinate system inversion method to obtain a propagation path of the stress waves reaching the borehole bottoms of the test boreholes in the region behind the tunnel face.

A fitting unit configured to fit the Sadovsky formula on the basis of the propagation path to obtain the second blasting vibration velocity prediction model in the region behind the tunnel face.

It should be noted that regarding the device in the aforementioned embodiment, the specific manner in which each module performs operations has been described in detail in the embodiments of the relevant method and will not be elaborated on here.

### Embodiment 3

Corresponding to the above embodiments of the method, further provided in the embodiment is an apparatus for predicting blasting vibration inside surrounding rocks of deep buried tunnels. The apparatus for predicting blasting vibration inside surrounding rocks of deep buried tunnels described below and the method for predicting blasting vibration inside surrounding rocks of deep buried tunnels described above may be cross-referenced.

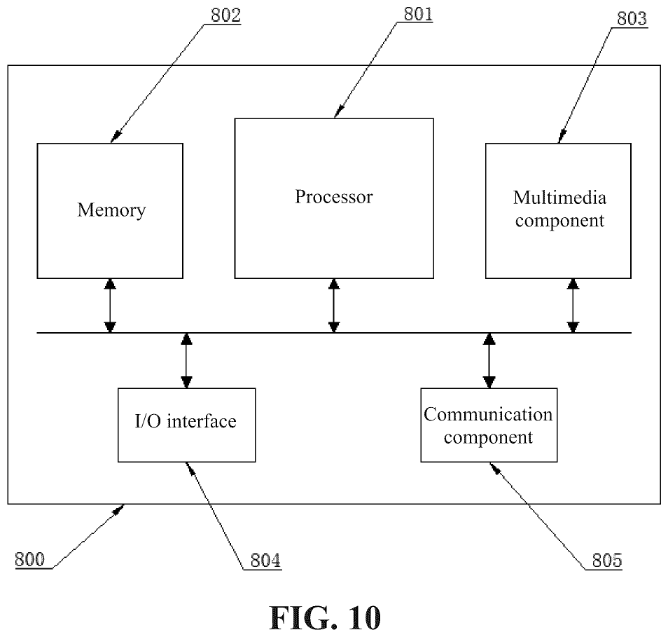

FIG. 10 is a block diagram showing an apparatus 800 for predicting blasting vibration inside surrounding rocks of deep buried tunnels according to an exemplary embodiment. As shown in FIG. 10, the apparatus 800 for predicting blasting vibration inside surrounding rocks in deep buried tunnels may include a processor 801 and a memory 802. The apparatus 800 for predicting blasting vibration inside surrounding rocks of deep buried tunnels can also include one or more of a multimedia component 803, an I/O interface 804 and a communication component 805.

Herein, the processor 801 is configured to control an overall operation of the apparatus 800 for predicting blasting vibration inside surrounding rocks of deep buried tunnels, thereby completing all or part of steps in the above method for predicting blasting vibration inside surrounding rocks in deep buried tunnels. The memory 802 is configured to store various types of data to support operations of the apparatus 800 for predicting blasting vibration inside surrounding rocks of deep buried tunnels, this data may include, for example, instructions for any application programs or methods operated on the apparatus 800 for predicting blasting vibration inside surrounding rocks of deep buried tunnels, as well as application-related data, such as contact data, messages sent and received, pictures, audio, video, etc. The memory 802 may be implemented by any type of volatile or non-volatile storage apparatuses or a combination thereof, such as Static Random Access Memory (SRAM for short), Electrically Erasable Programmable Read-Only Memory (EEPROM for short), Erasable Programmable Read-Only Memory (EPROM for short), Programmable Read-Only Memory (PROM for short), Read-Only Memory (ROM for short), magnetic memory, flash memory, magnetic disks, or optical disks. The multimedia component 803 may include a screen and an audio component. The screen may be, for example, a touch screen. The audio component is configured to output and/or input audio signals. For example, the audio component may include a microphone configured to receive external audio signals. The received audio signals may be further stored in the memory 802 or transmitted via the communication component 805. The audio component may also include at least one speaker for outputting the audio signals. The I/O interface 804 provides an interface between the processor 801 and other interface modules which may be a keyboard, mouse, buttons, etc. These buttons may be virtual buttons or physical buttons. The communication component 805 is configured for wired or wireless communication between the apparatus 800 for predicting blasting vibration inside surrounding rocks of deep buried tunnels and other apparatuses. Wireless communication may include, for example, Wi-Fi, Bluetooth, Near Field Communication (NFC for short), 2G, 3G, or 4G, or a combination of one or more thereof. Accordingly, the corresponding communication component 805 may include a Wi-Fi module, a Bluetooth module and an NFC module.

In an exemplary embodiment, the apparatus 800 for predicting blasting vibration inside surrounding rocks of deep buried tunnels may be implemented by one or more of Application Specific Integrated Circuits (ASIC for short), Digital Signal Processors (DSP for short), Digital Signal Processing Devices (DSPD for short), Programmable Logic Devices (PLD for short), Field Programmable Gate Arrays (FPGA for short), controllers, microcontrollers, microprocessors, or other electronic components, for executing the above method for predicting blasting vibration inside surrounding rocks in deep buried tunnels.

In another exemplary embodiment, further provided is a computer-readable storage medium including program instructions. The steps of the above method for predicting blasting vibration inside surrounding rocks in deep buried tunnels are achieved when the program instructions are executed by the processor. For example, the computer-readable storage medium may be the memory 802 including the program instructions, the above program instructions may be executed by the processor 801 of the apparatus 800 for predicting blasting vibration inside surrounding rocks of deep buried tunnels so as to complete the method for predicting blasting vibration inside surrounding rocks in deep buried tunnels.

### Embodiment 4

Corresponding to the above embodiments of the method, further provided in the embodiment is a computer-readable storage medium. The computer-readable storage medium described below and the method for predicting blasting vibration inside surrounding rocks of deep buried tunnels described above may be cross-referenced.

The computer-readable storage medium, wherein computer programs are stored on the computer-readable storage medium, and when the computer programs are executed by a processor, the steps of the above method for predicting blasting vibration inside surrounding rocks in deep buried tunnels are implemented.

The computer-readable storage medium may specifically be various computer-readable storage media capable of storing program codes, such as a USB flash drive, a portable hard drive, a Read-Only Memory (ROM), a Random Access Memory (RAM), a magnetic disk, or an optical disc.

The foregoing descriptions are merely preferred embodiments of the present invention and are not intended to limit the present invention. For a person skilled in the art, various modifications and changes may be made to the present invention. Any modifications, equivalent replacements, improvements, etc. made within the spirit and principles of the present invention shall fall within the scope of protection of the present invention.

The above descriptions are merely specific embodiments of the present invention. However, the scope of protection of the present invention is not limited thereto. Any person skilled in the art, within the technical scope disclosed in the present invention, may readily conceive of changes or substitutions, which should be covered within the scope of protection of the present invention. Therefore, the scope of protection of the present invention shall be subject to the scope of protection defined by the claims.

1. A method for predicting blasting vibration inside surrounding rocks in deep buried tunnels, comprising:
horizontally drilling a plurality of test boreholes from a pilot tunnel into the surrounding rocks, and mounting blasting vibration sensors in sequence at a borehole bottom of each test borehole, wherein the plurality of test boreholes using a tunnel face of a subsequent tunnel as a symmetry plane are uniformly distributed in a region in front of and behind the tunnel face;
performing blasting on the subsequent tunnel, and acquiring vibration data of the test boreholes that are collected by the blasting vibration sensors;
acquiring a blasting point distance for the test boreholes in the region in front of the tunnel face, and fitting a Sadovsky formula by using the vibration data and the blasting point distance of the test boreholes in the region in front of the tunnel face, thereby obtaining a first blasting vibration velocity prediction model in the region in front of the tunnel face;
acquiring a blasting charge amount of the subsequent tunnel, substituting the vibration data of the test boreholes in the region behind the tunnel face and the blasting charge amount into the first blasting vibration velocity prediction model, and performing calculation to obtain an actual blasting point distance that stress waves are propagated from a blasting source to the test boreholes; and
fitting the Sadovsky formula by using the actual blasting point distance and the vibration data of the test boreholes in the region behind the tunnel face to obtain a second blasting vibration velocity prediction model in the region behind the tunnel face, comprising:
acquiring center coordinates of borehole openings of the test boreholes in the region behind the tunnel face;
performing inversion according to the center coordinates of the borehole openings and drilling depths to obtain center coordinates of the borehole bottoms of the test boreholes in the region behind the tunnel face;
acquiring coordinates of the blasting source of the tunnel face, and according to the coordinates of the blasting source, the center coordinates of the borehole bottoms and the actual blasting point distance, performing inversion by using a coordinate system inversion method to obtain a propagation path of the stress waves reaching the borehole bottoms of the test boreholes in the region behind the tunnel face; and
fitting the Sadovsky formula on the basis of the propagation path to obtain the second blasting vibration velocity prediction model in the region behind the tunnel face,
wherein the blasting vibration sensors are mounted at the borehole bottom of each test borehole, and each blasting vibration sensor comprises:
a sensor body located at an upper part of the blasting vibration sensor;
an accommodation chamber located at a lower part of the blasting vibration sensor, wherein a blocking layer is provided between the accommodation chamber and the sensor body, and a plurality of through holes are provided in the accommodation chamber in a peripheral direction; and
a push-pull device located inside the accommodation chamber, wherein a top of the push-pull device is fixedly connected to a top surface inside the accommodation chamber, a plurality of support rods of the push-pull device extend outward along the plurality of through holes to come in contact with an inner wall of the test borehole, thereby fixing the blasting vibration sensor in the test borehole;
wherein the push-pull device comprises:
a push-pull rod, wherein a spring is provided inside the push-pull rod in a vertical direction, a slider is sleeved outside the push-pull rod in the peripheral direction, the slider axially slides along the push-pull rod, and a button is provided below the push-pull rod;
an end handle, wherein a clamping port is provided on a side wall of the end handle, and the end handle is fixedly connected to the button through the clamping port;
a rod cap, the rod cap being fixed to a top of the push-pull rod; and
a pulley assembly, the pulley assembly comprising a fixed pulley, the slider and a traction rope, wherein the fixed pulley is fixed to the rod cap, the slider is sleeved outside the push-pull rod and moves axially along the push-pull rod, one end of the traction rope is connected to the fixed pulley and the slider in sequence, and another end of the traction rope passes axially through an interior of the spring and then is connected to a hook.

2. The method according to claim 1, wherein the horizontally drilling the plurality of test boreholes from the pilot tunnel into the surrounding rocks comprises:
determining a horizontal height for drilling the test boreholes in a wall of the pilot tunnel, and determining a horizontal distance between two adjacent test boreholes;
acquiring the drilling depths of the test boreholes, wherein the drilling depths comprise a first depth and a second depth, and the plurality of test boreholes are drilled alternately according to the first depth and the second depth;
drilling at least 4 test boreholes in sequence in the region in front of the tunnel face according to the horizontal height, the horizontal distance, and the drilling depths; and
by using the tunnel face as the symmetry plane, symmetrically drilling an identical number of test boreholes in the region behind the tunnel face.

3. (canceled)

4. (canceled)

5. A system for predicting blasting vibration inside surrounding rocks in deep buried tunnels, comprising:
an arrangement module configured to horizontally drill a plurality of test boreholes from a pilot tunnel into the surrounding rocks, and mount blasting vibration sensors in sequence at a borehole bottom of each test borehole, wherein the plurality of test boreholes using a tunnel face of a subsequent tunnel as a symmetry plane are uniformly distributed in a region in front of and behind the tunnel face;
an acquisition module configured to perform blasting on the subsequent tunnel, and acquire vibration data of the test boreholes that are collected by the blasting vibration sensors;
a first fitting module configured to acquire a blasting point distance for the test boreholes in the region in front of the tunnel face, and fit a Sadovsky formula by using the vibration data and the blasting point distance of the test boreholes in the region in front of the tunnel face, thereby obtaining a first blasting vibration velocity prediction model in the region in front of the tunnel face;
a first calculation module configured to acquire a blasting charge amount of the subsequent tunnel, substitute the vibration data of the test boreholes in the region behind the tunnel face and the blasting charge amount into the first blasting vibration velocity prediction model, and perform calculation to obtain an actual blasting point distance that stress waves are propagated from a blasting source to the test boreholes; and
a second fitting module configured to fit the Sadovsky formula by using the actual blasting point distance and the vibration data of the test boreholes in the region behind the tunnel face to obtain a second blasting vibration velocity prediction model in the region behind the tunnel face, and comprising:
a third acquisition unit configured to acquire center coordinates of borehole openings of the test boreholes in the region behind the tunnel face;
a first inversion unit configured to perform inversion according to the center coordinates of the borehole openings and drilling depths to obtain center coordinates of the borehole bottoms of the test boreholes in the region behind the tunnel face;
a second inversion unit configured to acquire coordinates of the blasting source of the tunnel face, and according to the coordinates of the blasting source, the center coordinates of the borehole bottoms and the actual blasting point distance, perform inversion by using a coordinate system inversion method to obtain a propagation path of the stress waves reaching the borehole bottoms of the test boreholes in the region behind the tunnel face; and
a fitting unit configured to fit the Sadovsky formula on the basis of the propagation path to obtain the second blasting vibration velocity prediction model in the region behind the tunnel face.

6. The system according to claim 5, wherein the arrangement module comprises:
a first determination unit configured to determine a horizontal height for drilling the test boreholes in a wall of the pilot tunnel, and determine a horizontal distance between two adjacent test boreholes;
a first acquisition unit configured to acquire the drilling depths of the test boreholes, wherein the drilling depths comprise a first depth and a second depth, and the plurality of test boreholes are drilled alternately according to the first depth and the second depth;
a first arrangement unit configured to drill at least 4 test boreholes in sequence in the region in front of the tunnel face according to the horizontal height, the horizontal distance, and the drilling depths; and
a second arrangement unit configured to, by using the tunnel face as the symmetry plane, symmetrically drill an identical number of test boreholes in the region behind the tunnel face.
